(19) United States
(12) Patent Application Publication
(10) Pub. No.: US 2006/0257617 A1
(43) Pub. Date: Nov. 16, 2006

(54) Method and apparatus for providing a steering wheel with decorative trim

(76) Inventors: Barry C. Worrell, Centerville, OH (US); James J. Simpson, Fairborn, OH (US); John C. Weber, Springboro, OH (US)

Correspondence Address: SCOTT A. McBAIN, Esq.;DELPHI TECHNOLOGIES, INC., Legal Staff, Mail Code 480-410-202, P.O. Box 5052, Troy, MI, 48007-5052, US

(21) Appl. No.: 11/110,369

(22) Filed: Apr. 20, 2005

(51) Int. Cl. B05D 1/16

(52) U.S. Cl. 428/90

(57) ABSTRACT

A steering wheel, comprising: an inner core; a cushion member disposed about the inner core; a first decorative trim member disposed over the cushion member, the first decorative trim member comprising a flexible layer; and a second decorative trim member disposed over the first decorative trim member, the second decorative trim member being more rigid than the first decorative trim member wherein a portion of the first decorative trim member is abraded to remove a portion of an exterior surface of the first decorative trim member to provide a roughened area for receiving an adhesive for securing the second decorative trim member to the first decorative trim member.

### TECHNICAL FIELD

The present invention relates to steering wheels and more particularly the present invention relates to methods for attaching trim portions to a steering wheel.

### BACKGROUND

Steering wheels often have decorative coverings or decorative trim portions that cover areas of the steering wheel rim. Non-limiting examples of decorative trims are plastics, vinyl, and simulated or genuine leather. Leather is a very popular decorative trim covering for steering wheels, especially in luxury vehicles. Many drivers would also desire the rich appearance of a wood steering wheel. A solid wood steering wheel is impractical due to the difficulties in finding and making circular shape sections in fine-appearance wood and associated costs. However, using wood veneers thin sections can be applied to portions of the steering wheel that result in a steering wheel with a wood grain appearance for very economical manufacturing costs.

In addition, a steering wheel equipped with a combination of a decorative member of leather and a hard wood portion or simulated wood or other hard decorative portion (e.g., plastic or other moldable material) would also be desirable however, methods of adequately securing the decorative portion to the decorative layer of leather remain desirable. One method of attachment is disclosed in U.S. Pat. No. 6,401,567, the contents of which are incorporated herein by reference thereto.

Accordingly, it is desirable to provide a method and apparatus for securing a first decorative trim member or layer to a second decorative trim layer, wherein the first decorative trim layer is a flexible trim covering and the second decorative trim layer is a hard decorative trim portion, which covers a portion of the first decorative trim layer. Therefore, it is desirable to provide methods and apparatus for rigidly securing portions of ornate trim to another decorative layer of a steering wheel, wherein both decorative layers comprise an exterior surface of the steering wheel.

### SUMMARY OF THE INVENTION

Disclosed herein are methods and apparatus for rigidly securing portions of ornate trim to another decorative layer of a steering wheel. A steering wheel is provided having an inner core, a cushion member disposed about the inner core, a first decorative trim member disposed over the cushion member, and a second decorative trim member disposed over the first decorative trim member after the first decorative trim member is secured to the cushion member.

A steering wheel, comprising: an inner core; a cushion member disposed about the inner core; a first decorative trim member disposed over the cushion member, the first decorative trim member comprising a flexible layer; and a second decorative trim member disposed over the first decorative trim member, the second decorative trim member being more rigid than the first decorative trim member wherein a portion of the first decorative trim member is abraded to remove a portion of an exterior surface of the first decorative trim member to provide a roughened area for receiving an adhesive for securing the second decorative trim member to the first decorative trim member.

A steering wheel, comprising: a cushion member; a mounting member disposed over an exterior portion of the cushion member, the mounting member having a plurality of protrusions; a first decorative trim member disposed over the mounting member, the first decorative trim member comprising a flexible layer with a plurality of apertures configured and positioned to allow the plurality of protrusions to pass therethrough when the first decorative trim member is disposed over the mounting member; and a second decorative trim member disposed over the first decorative trim member, wherein the second decorative trim member is secured to the steering wheel.

A method for securing decorative trim members to a steering wheel, comprising: securing a mounting member to a first decorative trim member; disposing the first decorative trim member over a cushion portion of the steering wheel, wherein the mounting member and a portion of the first decorative trim member is disposed within a recessed area; and securing a second decorative trim member to the mounting member by applying an adhesive to the first decorative trim member and the mounting, wherein an outer surface of the second decorative trim member is flush with an outer surface of the first decorative trim member.

### BRIEF DESCRIPTION OF THE DRAWINGS

FIG. 1 is a view of a portion of a steering wheel;

FIG. 2 is a section of the steering wheel of FIG. 1;

FIG. 3 is a sectional view of a rim portion along lines 3-3 of FIG. 1, in accordance with an exemplary embodiment of the present invention;

FIGS. 4-7 are partial views of a first decorative trim layer of a steering wheel constructed in accordance with exemplary embodiments of the present invention;

FIG. 8 is a partial view of a mounting member for use with a steering wheel in accordance with an alternative exemplary embodiment of the present invention;

FIG. 9 is another partial view of a first decorative trim layer in accordance with an alternative exemplary embodiment of the present invention;

FIG. 10 is a cross-sectional view of a first decorative trim layer secured to a mounting member in accordance with an exemplary embodiment of the present invention;

FIG. 11 is a partial view of a rim portion showing a first decorative trim layer applied to a mounting member;

FIG. 12 is a partial view of a rim portion showing a second decorative trim layer applied to a mounting member and first decorative layer;

FIG. 13 is a view of a second decorative trim layer, in accordance with an exemplary embodiment of the present invention;

FIGS. 14 and 15 are partial views of a first decorative trim layer treated in accordance with exemplary embodiments of the present invention;

FIG. 16 is a partial view of a first decorative trim layer and a mounting member in accordance with an exemplary embodiment of the present invention;

FIG. 17 is a view of a steering wheel showing the joint connections of a first decorative trim layer in accordance with an exemplary embodiment of the present invention;

FIG. 18 is a perspective view of a steering wheel constructed in accordance with an exemplary embodiment of the present invention;

FIG. 19 is a cross-sectional view of a rim portion of a steering wheel constructed in accordance with another exemplary embodiment of the present invention;

FIG. 20 is a cross-sectional view of a rim portion of a steering wheel constructed in accordance with another exemplary embodiment of the present invention;

FIG. 21 is a cross-sectional view of a rim portion of a steering wheel constructed in accordance with another exemplary embodiment of the present invention;

FIG. 22 is a partial perspective view of a steering wheel constructed in accordance with an exemplary embodiment of the present invention; and

FIGS. 23-25 illustrate an alternative exemplary embodiment of the present invention.

### DETAILED DESCRIPTION OF EXEMPLARY EMBODIMENTS

Disclosed herein are methods for securing decorative trim to a steering wheel. More particularly, exemplary embodiments are directed to applying decorative wood trim over leather trim as applied to areas on a steering wheel.

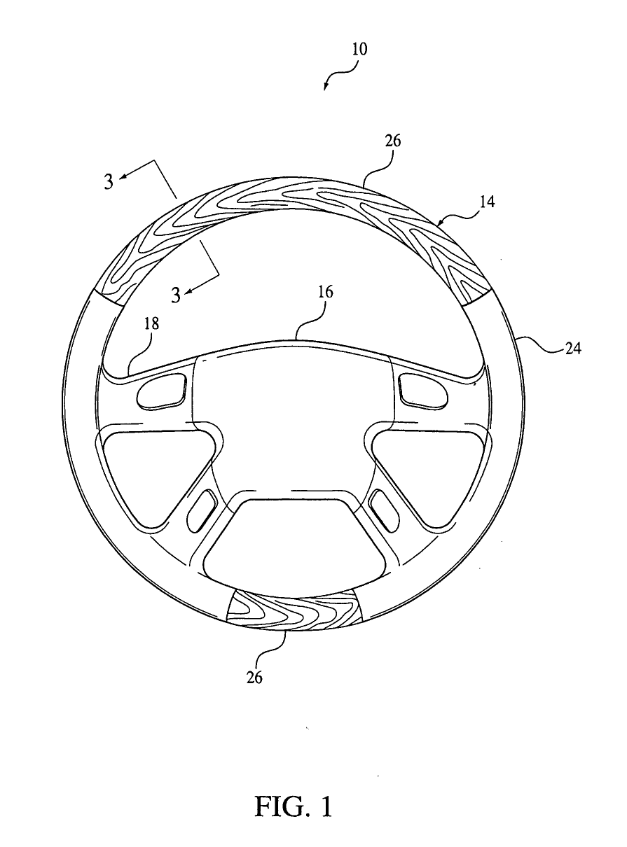

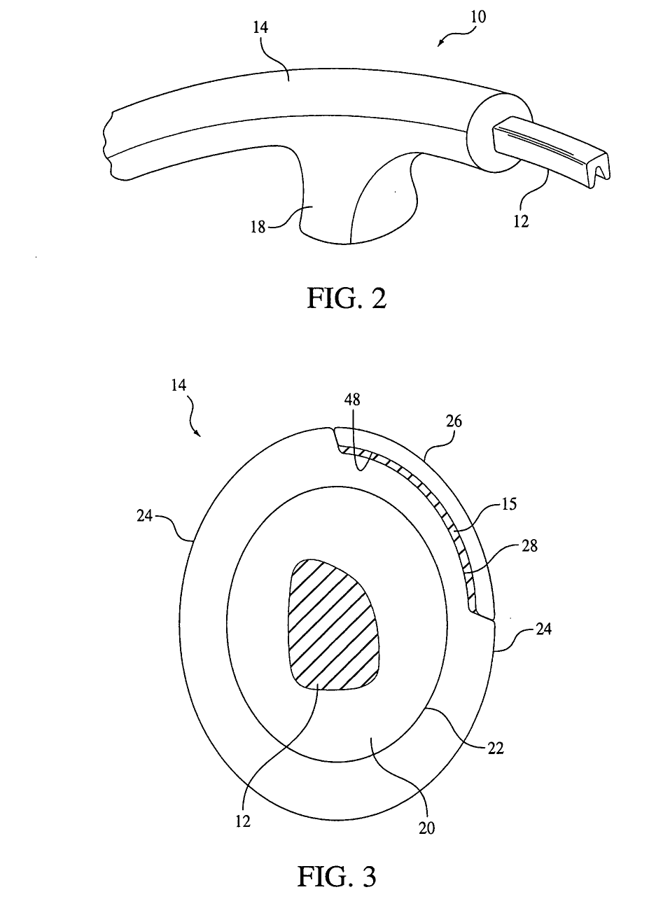

Referring now to FIGS. 1 and 2, a steering wheel 10 is illustrated. Steering wheel 10 comprises an inner core 12, a rim portion 14, a hub portion 16, and a plurality of spokes 18 for interconnecting the hub portion and the rim portion. In accordance with an exemplary embodiment inner core 12 is formed of a hardened, high-strength metal or plastic. It is necessary for the core member to be of sufficient size and strength material to withstand applied loads such as when the driver uses the steering wheel for leverage when entering and exiting the vehicle, or other required tolerances.

Rim portion 14 is typically a circular shaped member forming the outermost portion of the steering wheel 10. Hub portion 16 provides features and a region to which many other components attach including but not limited to a horn, airbag module and steering column components. In addition, there can be many variations in configuration and number of the spokes 18. Generally, it is desirable to have substantial regions of rim portion 14 without connecting spokes 18 providing the driver with rim portions 14 that are easy to grasp when steering.

FIG. 1 depicts steering wheel 10 with four spokes 18 interconnecting rim 14 and hub portion 16. A steering wheel constructed in accordance with an exemplary embodiment of the present invention may include spokes with individual covers, or a cover for two or more spokes. Spoke covers can be a plastic, vinyl or a veneer. The figures and accompanying discussion provide examples of the present invention and are not intended to be limited to the specific configurations illustrated in the attached figures.

Referring now to FIG. 3, an exemplary embodiment of the present invention is illustrated. As illustrated, steering wheel 10 also includes cushion member 20 that encloses the inner core 12, preferably around the outer rim and over the spokes. Cushion member 20 cushions inner core 12 to enhance the comfort of the steering wheel 10 for the operator's hands. Cushion member 20 is preferably made of a cushioning material such as polyurethane, which can be easily molded to conform to the shape of the inner core. In accordance with an exemplary embodiment of the present disclosure cushion member 20 is applied to inner core 12 by an injection molding process wherein cushion layer 20 is disposed about a portion of inner core 12.

Once cushion member 20 is molded about inner core 12 an outer cushion surface 22 is provided. In accordance with exemplary embodiments first decorative layer 24 is applied to outer cushion surface 22 and a second decorative layer or member 26 is applied to portions of first decorative layer 24. In various embodiments portions of first decorative layer 24 and second decorative layer 26 is positioned in recessed areas disposed about the periphery of the cushion member to provide a smooth outer surface. Alternatively, a mounting member for second decorative layer 26 is used to compress portions of the cushion member to provide a flush outer surface comprising first decorative layer 24 and second decorative layer 26. In this embodiment, the mounting member is a metal band, which encircles and comprises a portion of the periphery of the cushion surface.

In accordance with exemplary embodiments non-limiting examples of the first decorative layer 24 include a flexible layer of plastic, vinyl, and simulated or genuine leather, which is capable of being applied to outer cushion surface 22, and secured thereto by stitching ends of the first decorative layer 24 together as is known in the related arts. In addition, and as a secondary feature, a layer of adhesive 15 can be disposed between a portion of outer cushion surface 22 and first decorative layer 24 to bond layer 24 to cushion 20.

Often the materials or the exterior surface of the materials chosen for first decorative layer 24 do not possess ideal surface properties for adhesive bonding since they are primarily selected for their aesthetic appearance. One example of such a material is leather or simulated leather. Some plastics have smooth surfaces wherein an applied adhesive will slide away from a desired bonding location. In accordance with exemplary embodiments of the present invention, methods have been developed for treating contacting surfaces of first decorative layer 24 and second decorative layer 26 attached thereto. These treated surfaces thereby provide a strengthened bond connection for joining the first and second decorative layers.

In an exemplary first embodiment illustrated in FIG. 3, steering wheel 10 includes inner core 12, cushion member 20, first decorative layer 24, and second decorative layer 26. In this embodiment, first decorative layer 24 has been applied to cushion member 20. An example of first decorative layer 24 is a vinyl or leather wrapped rim portion 14 of steering wheel 10. It is desired to then apply second decorative layer 26 to specific regions of steering wheel 10 by adhesively bonding the second decorative layer 26 to first decorative layer 24. Thus, providing an exterior aesthetic surface that is part first decorative layer 24 and part second decorative layer 26. For instance, second decorative layer 26 can be a wood trim, veneer, or decorative plastic material disposed over a leather wrapping or vinyl outer layer 24. In one exemplary embodiment second decorative layer 26 comprises a plurality of laminated layers in order to provide an aesthetically pleasing outer appearance. In another embodiment second decorative layer 26 is configured to traverse the entire periphery of the rim portion and be disposed on top of the first decorative layer 24 disposed about rim portion 14 of steering wheel 10 (e.g. a circular member). In a non-limiting example illustrated in FIGS. 13 and 18, a one-piece second decorative layer 26 comprising wood trim is disposed on steering wheel 10. In other exemplary embodiments a plurality of second decorative layers 26 are disposed in discrete locations of steering wheel 10.

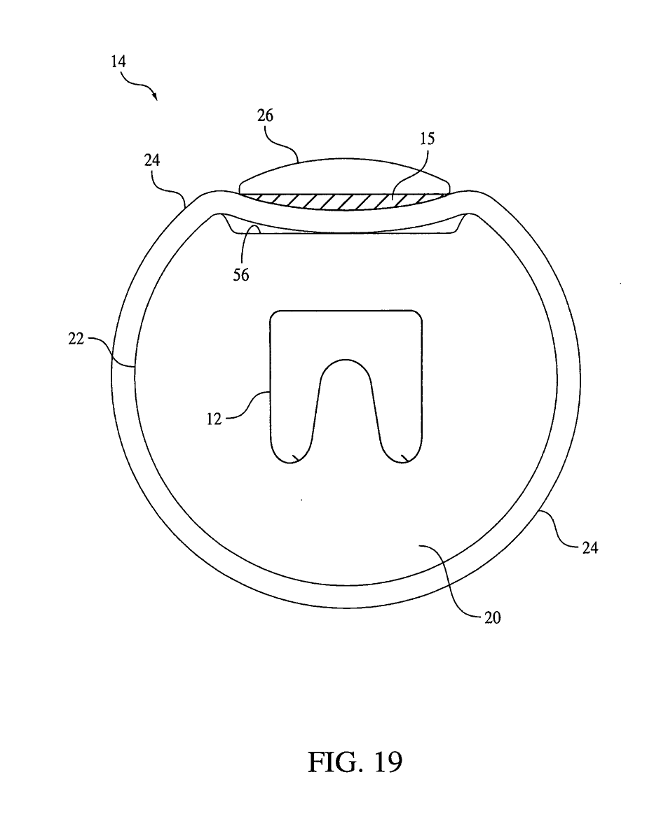

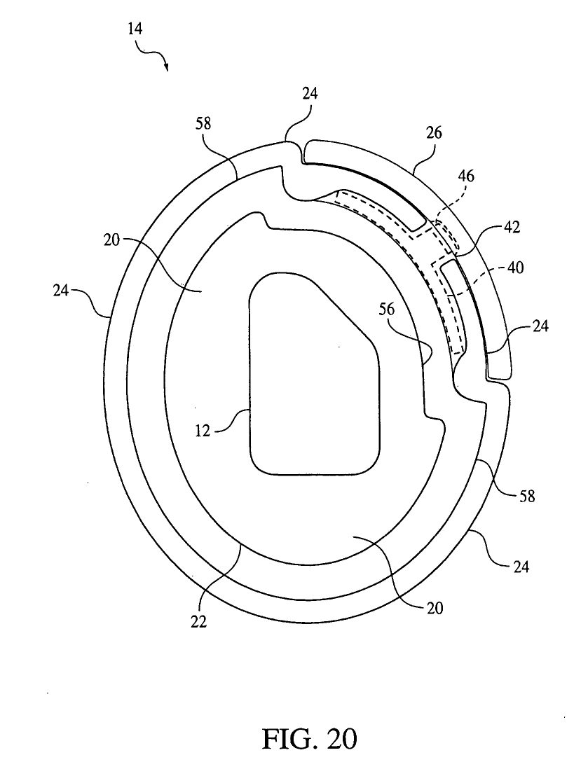

In an exemplary embodiment, second decorative layer 26, which is more rigid than the first decorative layer is applied to first decorative layer 24 so that a flush exterior surface interface is created between second decorative layer 26 and first decorative layer 24. This is achieved in one embodiment by compressing cushion member 20 when the second decorative layer is applied (e.g., use of a metal band to compress cushion layer), or as illustrated in FIG. 19, by providing a receiving area in cushion member 20 to receive second decorative layer 26 thereby providing a flush interface between first decorative layer 24 and second decorative layer 26.

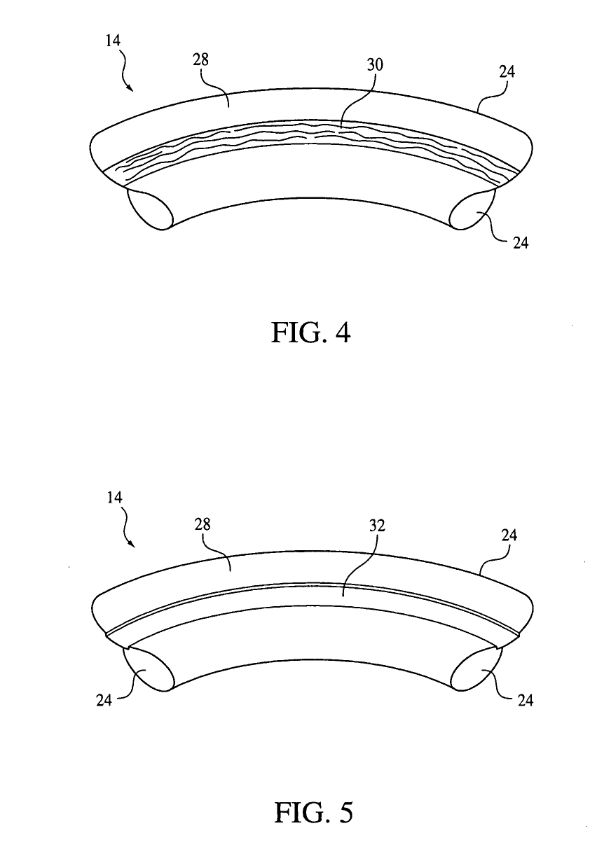

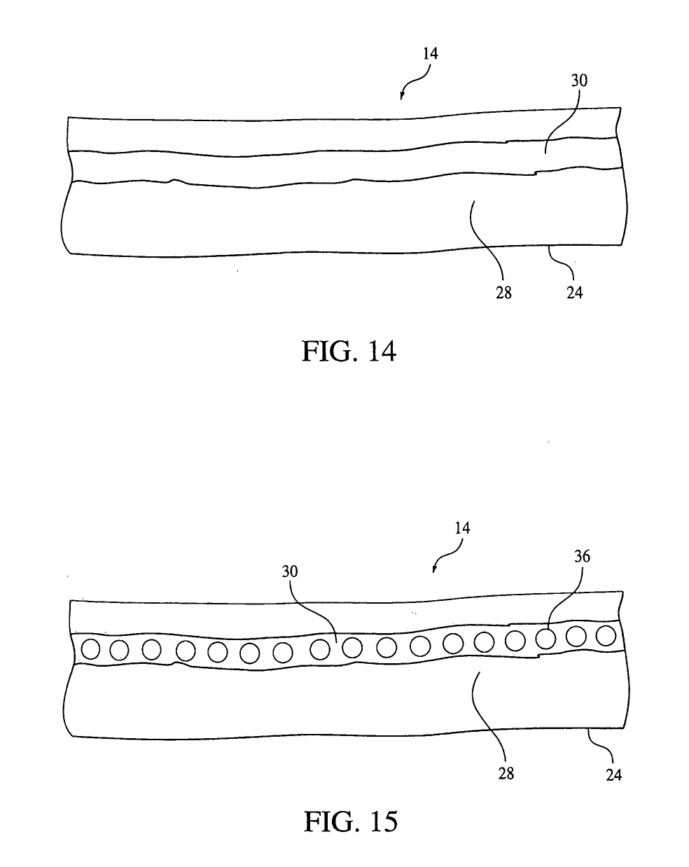

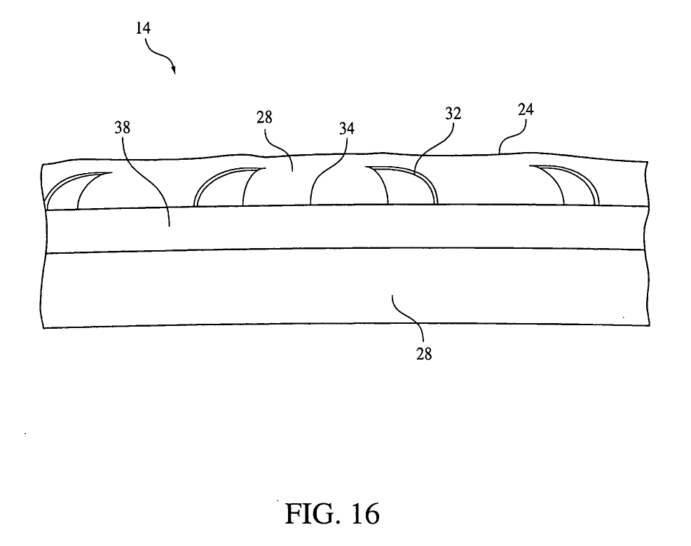

As previously discussed, an outer surface or portion 28 of the first decorative layer 24 is treated to strengthen the adhesive bond connection between first and second decorative layers. A roughening operation is one method of treating outer surface 28 of first decorative layer 24 creating a roughened surface 30, as illustrated in FIGS. 4 and 14, for strengthening the adhesive bond between first and second decorative layers. Roughened surface 30 comprises a plurality of peaks and valleys or receiving areas for adhesive 15. Receiving areas aid in retaining adhesive 15 applied to roughened surface 30. Moreover, for some first decorative layer materials, such as leather or vinyl, it is desirable to remove portions of the outermost layers of outer surface 28 prior to applying adhesive 15 and second decorative layer 26 because the outermost layers can have elements or characteristics not compatible with industrial adhesives. Additionally, outermost layers of first decorative layer 24 may comprise a sealant type coating that can peel off easier than inner portions of first layer 24 further necessitating the need to provide a surface suitable for receiving the adhesive.

One surface roughening method is abrading outer surface 28 of first decorative layer 24. In one exemplary embodiment illustrated in FIGS. 4, 14, a portion of or a majority of the periphery of outer surface 28 is abraded. A non-limiting example of the width of the abraded section is a groove having a width of approximately 6-8 millimeters wide. This can be accomplished by exposing the first decorative layer 24, such as a leather wrapped steering wheel 10, to a rotary type grinder to remove a layer of outer surface 28 from rim portions 14 of steering wheel 10. Abrading techniques can include manual or automated sanding and grinding operations.

An alternative treatment for creating the adhesive receiving area includes a skiving operation where at least one layer of outer surface 28 is removed. Essentially, a skiving operation is cutting away a groove 32 or recess into outer surface 28 as illustrated in FIG. 5. Groove 32 becomes the receiving area for adhesive 15 to strengthening the bond between second outer decorative layer 26 and first decorative layer 24. Another alternative surface treatment is to make a series of cuts on the outer surface 28 of the first decorative trim layer 24 to expose the unfinished edges to strengthen the adhesive bond connection between second outer decorative layer 26 and first decorative layer 24. Alternative surface treating techniques can include a chemical etching, coating or other processing of the surfaces to be joined with the same goal of strengthening the bond connection between mating members.

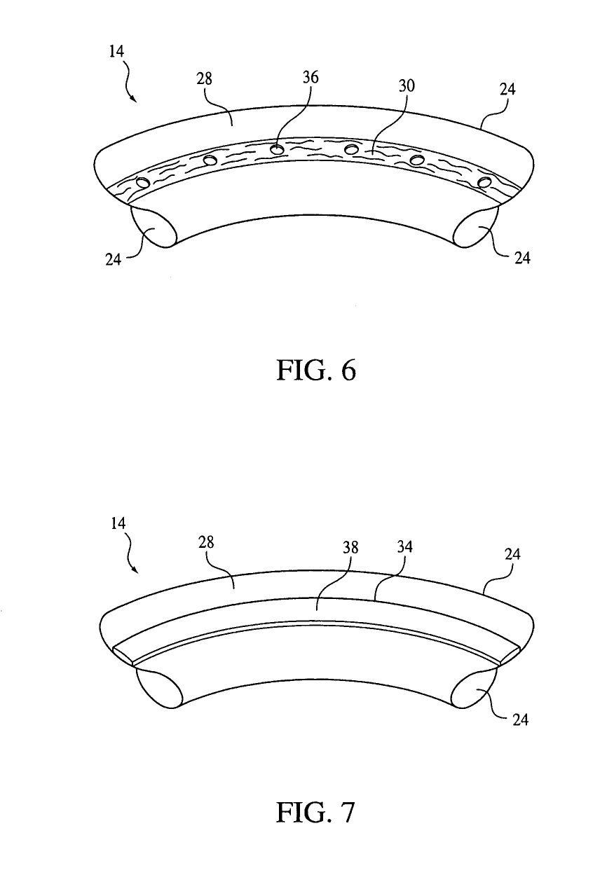

In yet another exemplary embodiment illustrated in FIGS. 6 and 15 another method of creating receiving areas for adhesive 15 is to include a plurality of apertures 36 or indentations spaced apart at outer surface 28 of first decorative layer 24. A non-limiting example is a plurality of holes 36 where each hole is approximately 3 millimeters in diameter cut into first decorative layer 24 before it is applied over cushion member 20. Of course, holes 36 may have diameters greater or less than 3 millimeters or comprise non-circular openings. In another alternative exemplary embodiment, outer surface 28 can be configured to include a plurality of raised protrusions or bumps, rather than holes, to control adhesive film thickness between first and second layers.

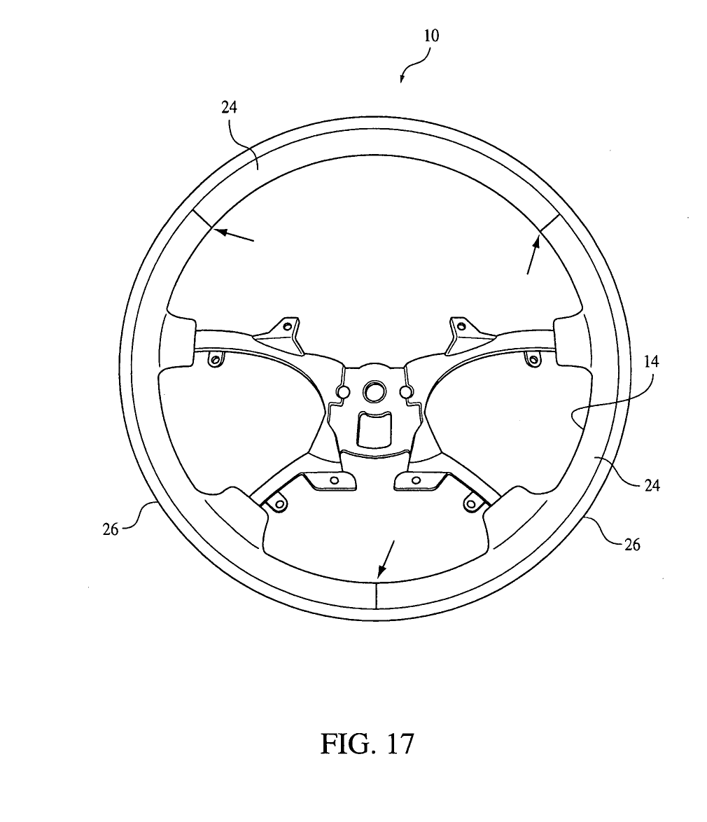

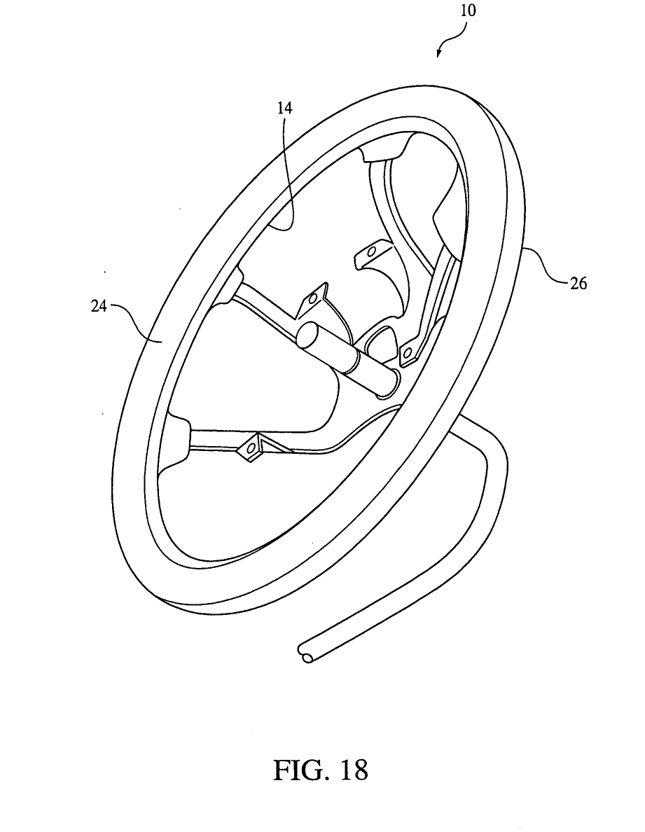

After treating outer surface 28, industrial adhesive 15 is applied to treated surface 30, groove 32, and or apertures 36 for bonding to second decorative layer 26. As illustrated in FIG. 17, surface 28 will not be treated proximate joint or seam locations (highlighted with arrows in FIG. 17) of first decorative layer 24 to avoid compromising joint integrity. Then second decorative layer 26 is applied to desired regions of first decorative layer 24 where the adhesive 15 permanently joins the two layers securely together. The processes used to adhesively bond mating layers include steps commonly used by those skilled in the art such as but not limited to applying heated adhesive, applying pressure or clamping techniques, and allowing the adhesively bonded assembly time to cure. The type of process used including the amount of time that pressure or clamping is applied and cure times will depend on factors such as but not limited to the steering wheel configuration, materials, and the adhesive.

It should be noted that outer surface 28 could be treated using various combinations of the techniques previously discussed. For example, portions of outer surface 28 of a leather wrapped steering wheel 10 can be only abraded or skived before second decorative layer 26 comprising a wood trim is glued on. In an alternative configuration, holes 36 or indentations can be applied to layer 24 before it is applied to cushion member 20. Holes 36 or indentations can replace the abrading or skiving operation or they can be applied in addition to the abrading or skiving operation applied to first decorative layer 24 as illustrated in FIG. 15. Adhesive 15 is then applied to regions of layer 24 having been abraded, skived or having holes before applying second decorative layer portion 26 to layer 24. It should be noted that terms “first,” or “second” used to reference individual layers should not be considered limiting as to the numbers of layers possible for the embodiments discussed herein. The surface treatment and mounting techniques can be used for embodiments having more than two decorative layers.

In an alternative exemplary embodiment, illustrated in FIG. 7, steering wheel 10 includes inner core 12, cushion member 20, first decorative layer 24, at least one mounting member 34, and second decorative layer 26. In this embodiment, first decorative layer 24 is first applied over outer cushion surface 22 as in the first embodiment. Then mounting member 34 is applied to outer surface 28 of first decorative layer 24 and the second decorative layer 26 is then applied over mounting member 34.

In this exemplary embodiment, mounting member 34 is generally a thin cross-section metal or plastic material. The purpose of mounting member 34 is to provide yet another alternative mounting surface for bonding second decorative layer 26 to steering wheel 10. As in prior embodiments, contact surfaces of members bonded together can be treated to strengthen the adhesive bond between bonded members. Specifically, an outer surface 38 of mounting member 34 can be abraded, skived, coated, or chemically treated to increase bond strength between mounting member 34 and second outer decorative layer 26.

In addition to having mounting member 34 whose outer surface 38 is treated, any of the previously discussed surface treating combinations can be applied to the first decorative layer 24 or mounting member 34 to strengthen bonding between layer 24, mounting member 34, and second decorative layer 26. For instance, a portion of outer surface 28 of first layer 24 is skived proximate to mounting member 34. An alternative embodiment can include cushion member 20 having a recess 56 configured for receiving mounting member 34 and first and second decorative layers. Furthermore, in another exemplary embodiment inner surface 48 of second decorative layer 26 can be treated by methods to strengthen its adhesive bond with layer 24 or mounting member 34. In another alternative exemplary embodiment, outer surface 38 can be configured to include a plurality of raised protrusions or bumps, rather than holes, to control adhesive film thickness between mounting member 34 and second outer layer 26. Mounting member 34 can be configured to include a hook and engagement features for clasping mounting member 34 tightly in a circumferential direction to the first outer decorative trim layer 24. In this embodiment, mounting member 34 may be used to compress portions of cushion member 20 so that a flush surface is provided between first decorative trim layer 24 and second decorative trim layer 26.

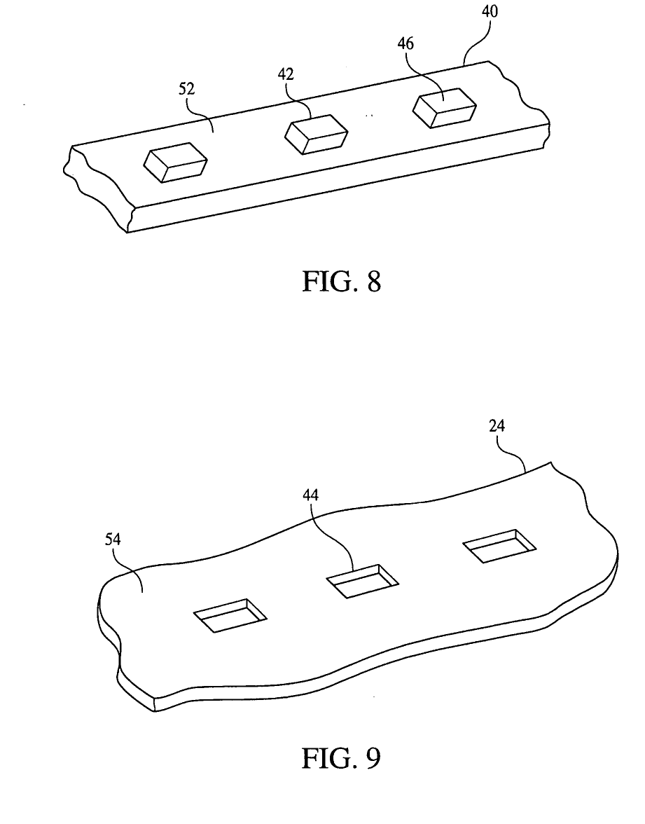

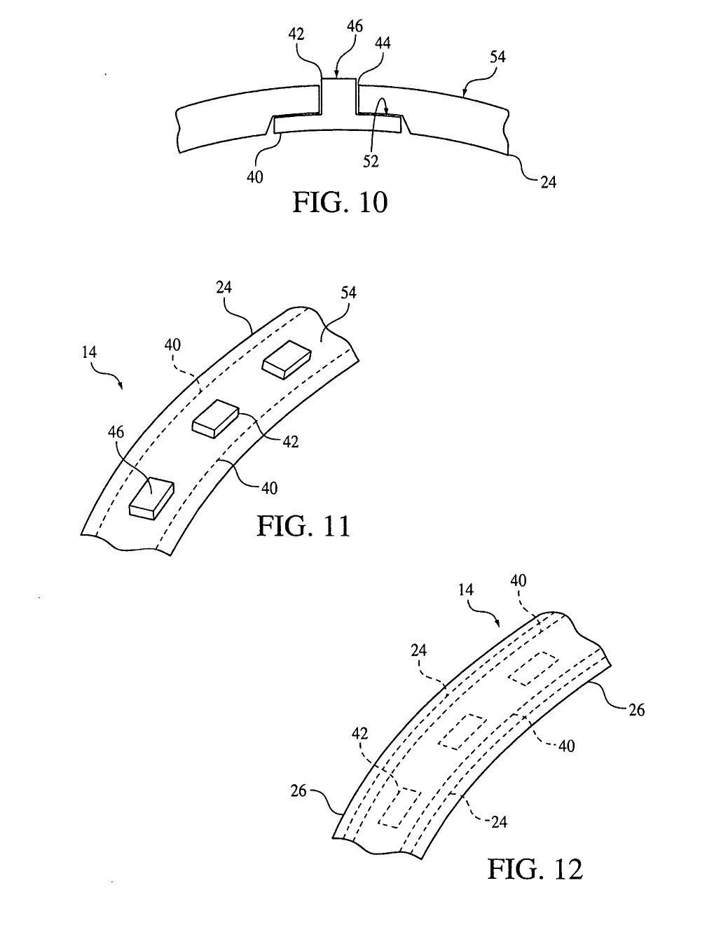

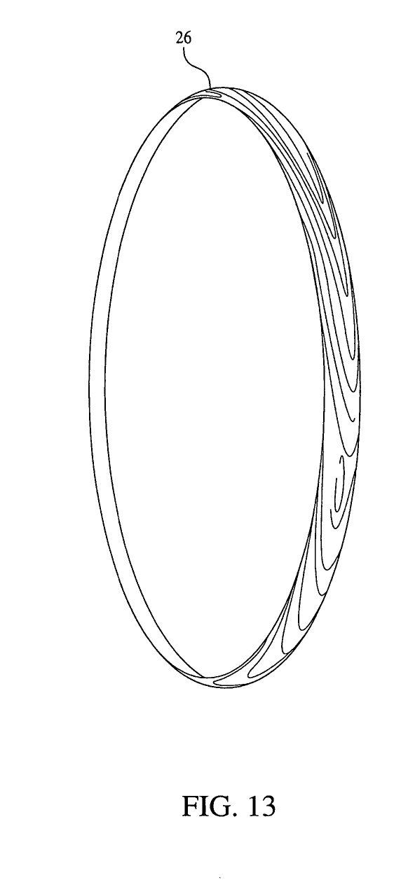

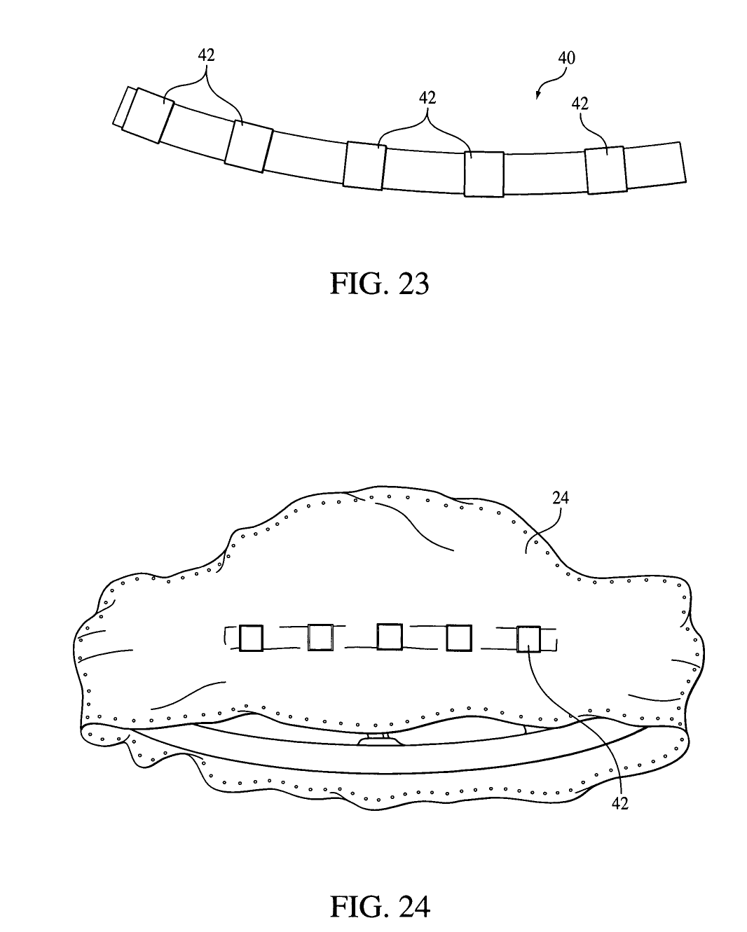

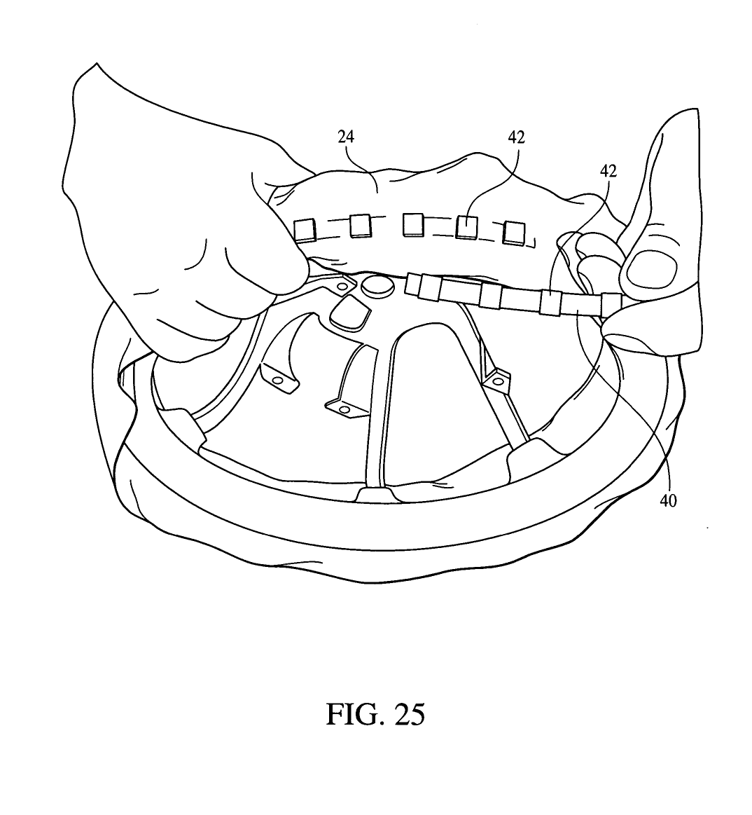

In yet another exemplary embodiment, illustrated in FIGS. 8-12 and 23-25, steering wheel 10 includes inner core 12, cushion member 20, at least one mounting member 40, first decorative layer 24, and second decorative layer 26. In this embodiment, mounting member 40 is configured to have a plurality of protrusions 42 depending from a surface 52 of the mounting member. In this embodiment, mounting member or surface 52 is configured to match the curvature of the rim of the steering wheel to which it is being applied. Alternatively, mounting member 40 is flexible in nature thereby being able to be manipulated to the curvature of the steering wheel. In accordance with this embodiment, first decorative layer 24 is configured to have a plurality of apertures 44. Apertures 44 are configured and positioned to allow protrusions 42 to extend therethrough when first decorative layer 24 is applied over surface 52 of mounting member 40 as illustrated in FIGS. 10-12. Mounting member 40 is positioned behind first decorative layer 24 and then the first decorative layer 24 is secured to outer cushion surface 22 of steering wheel 10 by stitching methods, which are know to those skilled in the related arts. Another embodiment can include adhesively bonding first decorative layer 24 to cushion surface 22. In accordance with this exemplary embodiment, protrusions 42 extend a distance away from surface 52 allowing mounting portions to protrude though apertures 44 of first layer 24 toward inner surface 48 of the second layer 26. Second decorative layer 26 is then applied over outer surface 54 of decorative layer 24 and adhesively bonded to layer 24.

Protrusions 42, apertures 44, and second layer 26 are configured so that an upper surface 46 of protrusions 42 contacts and adhesively bonds with inner surface 48 of second layer 26 when it is applied over first layer 24. In this embodiment, a portion of first decorative layer 24 is sandwiched between mounting member 40 and second decorative layer 26. In addition, mounting member 40, surface 52, protrusions 42, and protrusion upper surfaces 46 aid in preventing relative movement between adhesively bonded first and second decorative layers and mounting member 40. As with the prior embodiments, surfaces to be adhesively bonded can be treated with the methods discussed above to strengthen the adhesive bond connection. For instance, upper surfaces 46, surface 52, outer surface 28, and inner surface 48 of second decorative layer 26 can be treated in the above discussed methods to strengthen adhesive bonding. Additionally, protrusions 42 and apertures 44 can be configured so that a minimum space exists between protrusions 42 and the periphery of apertures 44 so an adhesive 15 film can fill the void providing a stronger bonded connection between mounting member 40 and first and the second decorative layers.

Protrusions 42 and apertures 44 are not intended to be limited to the embodiments discussed and illustrated. Their configuration, dimensions, and location can vary depending on the steering wheel and decorative layer design and materials. Mounting member 40 can be made of metal or plastic materials such as Acrylonitrile-Butadiene-Styrene copolymer (ABS). The ABS material can also include glass fibers or polycarbonate for increasing impact, tensile, or flexural strength properties to name a few. It is also desired that the mounting member 40 possess good bonding characteristics to allow use of most commercial high-strength adhesives without degradation of the material.

In an exemplary embodiment, mounting member 40 will be disposed over an arc segment of the circumference of the steering wheel. In one embodiment plurality of mounting members will be used, each being disposed about a circumference portion of rim portion 14 of steering wheel 10, while a single second decorative trim layer may be applied or a plurality of decorative trim layers may be applied. Mounting member 40 may not cover the entire rim portion 14 circumference due a number of reasons such as avoiding spoke to rim portion interface or other steering wheel components. More than one mounting member 40 can be disposed on regions of steering wheel 10 depending on the steering wheel design, configuration or intended placement of decorative members. Of course, a mounting member 40 covering the entire periphery of the rim may also be used. In addition, protrusions 42 may be configured to have features configured to engage securement openings in the non-show surface of the second decorative layer.

In one non-limiting exemplary embodiment, six mounting members each having six protrusions are used to secure second decorative layer 26 to the steering wheel.

In yet another, alternative exemplary embodiment a recess 56 in cushion member 20, as illustrated in FIG. 19, and/or thinning of appropriate portions of first decorative layer 24, can further aid in maintaining desired cross-sectional thickness of rim portion 14 along the circumference of steering wheel 10. For instance, use of recess 56 can provide additional space for steering wheel components such as but not limited to heater elements, foam pads, or circuitry embedded in rim portion 14. Additionally, various combinations of mounting members, recesses, grooves and surface treatments and application of adhesive can be used to provide steering wheels with multiple layers of decorative trim. Thus, once applied first decorative layer 24 and second decorative layer 26 both provide a portion of the exterior surface of the steering wheel rim.

For instance in another exemplary embodiment illustrated in FIG. 20, steering wheel 10 includes inner core 12, cushion member 20, an intermediate layer 58, first decorative layer 24, and second decorative layer 26. In this embodiment, intermediate layer 58 is disposed between cushion member 20 and first decorative layer 24. Intermediate layer 58 can be a material unlike the decorative layers, such as foam padding, that accommodates unlike behavioral characteristics of the decorative layers. In another alternative embodiment and illustrated by the dashed lines in FIG. 20, mounting member 40 having protrusion 42 is disposed between intermediate layer 58 and first decorative layer 24. In this embodiment a portion of inner surface 48 of second decorative layer is bonded to protrusion 42.

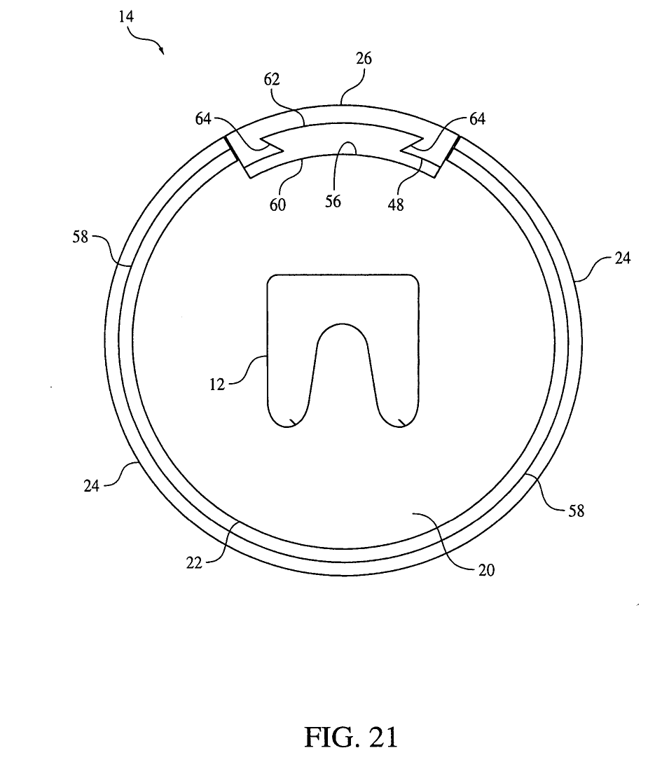

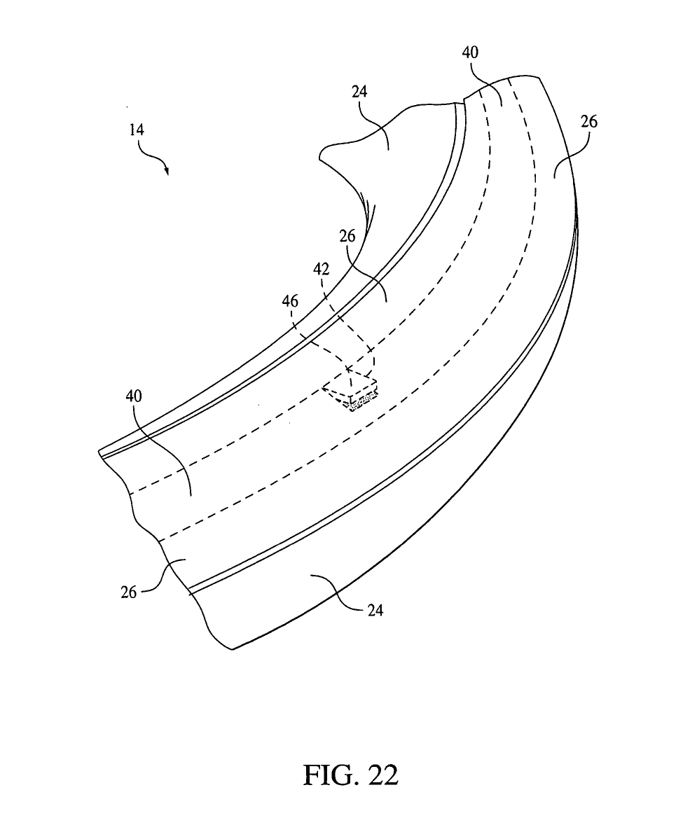

In yet another alternative embodiment illustrated in FIG. 21, steering wheel 10 includes inner core 12, cushion member 20, intermediate layer 58, at least one mounting member 60, first decorative layer 24, and second decorative layer 26. In this embodiment, mounting member 60 includes at least one protrusion 62 having surfaces 64 configured to interlock with corresponding surfaces of inner surface 48 of second decorative member 26. Furthermore, in this embodiment, portions of intermediate layer 58 and first decorative layer 24 can be removed for proving additional space for including components such as the mounting member 60 and second decorative layer 26. In yet another alternative embodiment illustrated in FIG. 22, steering wheel 10 includes mounting member 40 having at least one protrusion 42 a portion of which depends away from the outboard surface of mounting member 40 in a direction toward the second decorative trim layer 26. In this embodiment, protrusion 42 creates adhesive receiving areas beneath the protrusion and at the raised portion of the periphery of the protrusion.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A steering wheel, comprising:
an inner core;
a cushion member disposed about the inner core;
a first decorative trim member disposed over the cushion member, the first decorative trim member comprising a flexible layer; and
a second decorative trim member disposed over the first decorative trim member, the second decorative trim member being more rigid than the first decorative trim member wherein a portion of the first decorative trim member is abraded to remove a portion of an exterior surface of the first decorative trim member to provide a roughened area for receiving an adhesive for securing the second decorative trim member to the first decorative trim member.

2. The steering wheel as in claim 1, wherein the roughened area provides a receiving area for receiving the adhesive and the cushion member is configured to have a receiving area for receiving a portion of the first decorative trim member and the second decorative trim member, wherein an outer surface of the second decorative trim member is flush with the first decorative trim member.

3. The steering wheel as in claim 1, wherein an inner surface of the second decorative trim member is provided with a receiving area for receiving the adhesive.

4. The steering wheel as in claim 1, wherein the flexible layer is leather.

5. The steering wheel as in claim 4, wherein the second decorative trim member is wood veneer and is circular in shape.

6. The steering wheel as in claim 1, wherein a plurality of second decorative trim members are secured to the steering wheel.

7. A steering wheel, comprising:
an inner core;
a cushion member disposed about the inner core;
a first decorative trim member disposed over the cushion member, the first decorative trim member comprising a flexible layer;
a mounting member disposed over the first decorative trim member after the first decorative trim member is secured to the cushion member; and
a second decorative trim member disposed over the mounting member, wherein the second decorative trim member is secured to the steering wheel.

8. The steering wheel as in claim 7, wherein the cushion member has a receiving area configured for receiving a portion of the first decorative trim member and the second decorative trim member, wherein an outer surface of the second decorative trim member is flush with the first decorative trim member.

9. The steering wheel as in claim 7, wherein an inner surface of the second decorative trim member is provided with a receiving area for receiving an adhesive for securing the second decorative trim member to the steering wheel.

10. The steering wheel as in claim 7, wherein the flexible layer is leather.

11. The steering wheel as in claim 10, wherein the second decorative trim member is wood veneer and is circular in shape.

12. The steering wheel as in claim 7, wherein a plurality of second decorative trim members are secured to the steering wheel.

13. The steering wheel as in claim 7, wherein the mounting member is a metal band and the metal band compresses a portion of the cushion member to provide a receiving area for receiving the second decorative trim member, wherein an outer surface of the second decorative trim member is flush with an outer surface of the first decorative trim member.

14. The steering wheel as in claim 13, wherein the metal band includes a hook and an engagement portion for clasping the metal band about the first decorative trim member.

15. A steering wheel, comprising:
a cushion member disposed about a rim portion of the steering wheel;
a mounting member disposed over an exterior portion of the cushion member, the mounting member having a plurality of protrusions;
a first decorative trim member disposed over the mounting member, the first decorative trim member comprising a flexible layer with a plurality of apertures configured and positioned to allow the plurality of protrusions to pass therethrough when the first decorative trim member is disposed over the mounting member; and
a second decorative trim member disposed over the first decorative trim member, wherein the second decorative trim member is secured to the plurality of protrusions.

16. The steering wheel as in claim 15, wherein a portion of the first decorative trim member is abraded to remove a portion of an exterior surface of the first decorative trim member to provide a roughened area for receiving an adhesive for securing the second decorative trim member to the first decorative trim member.

17. The steering wheel as in claim 15, wherein an inner surface of the second decorative trim member is provided with a receiving area for receiving an adhesive and a portion of the plurality of protrusions of the mounting member.

18. The steering wheel as in claim 15, wherein the flexible layer is leather and a plurality of mounting members are used to secure a plurality of second decorative trim members to the steering wheel, wherein the plurality of mounting members are configured to be positioned about arcuate portions of the cushion member.

19. The steering wheel as in claim 15, including a recessed area provided in the cushion member, wherein the recessed area is configured such that the exterior surface of the second decorative trim member is flush with an exterior surface of the first decorative trim member when the second decorative trim member is disposed over the mounting member in the recessed area.

20. The steering wheel as in claim 19, futher comprising an intermediate layer disposed between the cushion member and the second decorative trim member.

21. The steering wheel as in claim 20, wherein the mounting member is disposed within the recessed area.

22. The steering wheel as in claim 15, wherein the second decorative trim member is a plastic member and the mounting member is plastic.

23. The steering wheel as in claim 15, wherein a plurality of second decorative trim members are secured to the steering wheel.

24. A method for securing decorative trim members to a steering wheel, comprising:
securing a mounting member to a first decorative trim member;
disposing the first decorative trim member over a cushion portion of the steering wheel, wherein the mounting member and a portion of the first decorative trim member is disposed within a recessed area; and
securing a second decorative trim member to the mounting member by applying an adhesive to the first decorative trim member and the mounting member, wherein an outer surface of the second decorative trim member is flush with an outer surface of the first decorative trim member.
